(19) United States
(12) Patent Application Publication
(10) Pub. No.: US 2003/0126156 A1
(43) Pub. Date: Jul. 3, 2003

(54) Duplicate resolution system and method for data management

(76) Inventors: Jay A. Stoltenberg, Bethel Park, PA (US); Sheri L. Stoltenberg, Bethel Park, PA (US)

Correspondence Address: MCKAY & ASSOCIATES, PC., 801 MCNEILLY ROAD, PITTSBURG, PA, 15226, US

(21) Appl. No.: 10/325,796

(22) Filed: Dec. 20, 2002

Related U.S. Application Data
(60) Provisional application No. 60/344,919, filed on Dec. 21, 2001.

(51) Int. Cl. G06F 7/00

(52) U.S. Cl. 707/104.1

(57) ABSTRACT

A system is provided for merging hospital database records and assuring real-time patient field updates during registration processes. A find tool identifies potential duplicate records, data overlays and duplicate guarantor numbers within a master patient index (MPI) or enterprise master patient index (EMPI) database of a hospital database. After the data is scored, a merge tool merges the data and gives the user the ability to review potential duplicate records online and decide on an operation to be performed thereon. A guard tool complements the merge tool as a means for preventing duplicate records and data overlays during the registration process. The user can continue with the new registration or choose an existing record from the duplicate matching screen as the data is inputted, thereby keeping the current inputs clean in “real-time.”

### SPECIFIC REFERENCE

The present invention claims priority so established by provisional application serial No. 60/344,919, filed Dec. 21, 2001.

### COMPUTER PROGRAM LISTING APPENDIX

This specification herein incorporates by reference one COMPUTER PROGRAM LISTING APPENDIX on compact disk.

### FIELD OF THE INVENTION

The present invention relates generally to data management systems implementing duplicate record resolution methods. In particular, the present system and methodology provides for duplicate data record merging and reporting, wherein multiple data fields, including guarantor records, are analyzed in groups for exact and probabilistic data overlaps.

### DESCRIPTION OF THE RELATED ART

Decentralized registration and multiple points of entry leave organizations vulnerable to data entry errors in correct personnel, patient, or equipment identification and registration. In the healthcare field, for example, it has become vital for health care organizations to identify patient record overlap and duplicate records within all local systems before establishing an enterprise data repository. It is well known that the existence of duplicate records can increase an organization's operating costs and delay payments back to the organization.

A typical hospital master patient index (MPI) contains five to ten percent duplicate patient records. This rate can increase dramatically if multiple MPIs are merged without prior analysis to eliminate, or at least minimize, duplicate patient records. The presence of duplicate records within a system can further cause increased staffing costs, increased patient registration time, fragmented patient or personnel information, and delay in patient care or treatment. Furthermore, film management problems for departments such as the radiology department can occur, ultimately leading to increased exposure to liability due to delay and/or errors in patient care or treatment.

There are conventional systems that locate duplicate data records within a database and delete those duplicate data records, but these systems only locate those data records which are identical to each other. Thus, these conventional systems cannot determine if two data records, with, for example, slightly different last names, nevertheless contain information about the same patient.

There are also systems that attempt to index data records from a plurality of different information sources and link the data records together that may contain information about the same entity. U.S. Pat. No. 5,991,758 to Ellard, for example, teaches a system and method which indexes data records within one or more information sources and determines which data records within the one or more information sources may contain information about the same entity and link the information together.

Drawbacks in the above systems and other conventional systems exist inasmuch as data records are compared and/or linked only in pairs by the matching of two predetermined fields. Furthermore, these systems suffer generally in that new data inputs occurring for a subsequent patient registration must continuously undergo a record matching process without the user knowing whether or not the inputs have been previously linked.

It would be appreciated then, that a system and method be provided that identifies and merges all potential duplicate records by group comparison to weight all possible duplicates, and automatically provide to the user any previous record that was merged or bypassed during a registration process, thereby providing a means for updating the hospital database in “real-time.” The present invention provides for a more robust and application service provider (ASP) enabled system for more probabilistically evaluating and merging duplicate data.

### SUMMARY OF THE INVENTION

The tools, as described herein, are designed to search through a hospital patient database and find all of the potential duplicated patient records (Find Tool), identify the probability that they are indeed duplicates, allow for the editing and merging of those duplicates (Merge Tool), or send them for further review. After the electronic merge of these records, they are transmitted back to the hospital at regular intervals for integration into their database. Once all of the duplicates have been merged, these tools are used to screen new patients as they enter the system (Guard Tool) to determine if they already have existing records to thereby prevent duplicate records from being created.

The find tool is a means for identifying potential duplicate records, data overlays, and duplicate guarantor numbers within a master patient index (MPI) or enterprise master patient index (EMPI) database. Both exact and probabilistic matching algorithms determine a match score for each potential duplicate record within a group. Each data element has a weight assigned thereto in order to calculate a match score. The score is then converted to a percentage that these records are of the same person. The scores below a certain point are discarded. The records above the score are returned to the potential duplicate record queue. The process is capable of returning multiple potential duplicates to the queue, such that more than two records that score high enough as a possible match will be returned for possible merging. It is also able to be customized to account for special data field comparisons based on differing hospital recording procedures. The scoring can also be adjusted to account for use of additional or fewer field comparisons.

Using the scored data from the find tool, the merge tool then merges duplicate patient and guarantor records and gives the user the ability to review potential duplicate records online and decide whether to merge, bypass (not merge), or send the record to a review queue. There is no limit on the number of duplicate files displayed. The process of merging the records is preferably done on the system over an encrypted connection across a network such as the Internet. Once a duplicate record has been merged, the merge tool communicates the merged data back to all designated local systems for merging within those systems. The merge tool works with both enterprise and local MPI databases, thereby allowing a client to retain one or more medical record numbers (MRNs) for a particular patient record.

The review queues allow a user to review potential duplicate records and make a decision on whether to merge, bypass, or send the records to a supervisor review or chart pull queue. A user has the ability to review and/or process duplicate records from any review queue. Report screens are view-only and contain the duplicate records processed for that day. The user has the ability to download and print any of the standard reports from the report screens. Cumulative versions of these report screens can also be viewed and/or printed.

Furthermore, a guard tool as described herein is a means for complementing the merge tool as an application for the prevention of duplicate records and data overlays during the registration process. The user can continue with the new registration or choose an existing record from the duplicate matching screen as the data is inputted, thereby keeping the current inputs clean in “real-time.” If an existing record is selected, the registration screen will be automatically updated with the patient or guarantor name and demographic information. The user can then simply verify the information.

Accordingly, what is provided is a duplicate resolution system and method for allowing a user to manage hospital database records in a hospital database, comprising the steps of loading the hospital database records into a host database to allow for an identifying of potential duplicate data within the hospital database; scoring the potential duplicate data using matching routines; allowing a user to review the potential duplicate data online from the host database; allowing the user to perform one or more operations on the potential duplicate data based on the score, wherein at least one of sthe operations is adapted to merge two or more potential duplicates in the potential duplicate data into one record; and, preventing new duplicate data during a registration process by allowing the user to query the host database to indicate a likelihood that any new duplicate data is a match to an existing record within the hospital database. After the step of loading the hospital database records, one or more fields of the potential duplicate data may be read into an array to form groups for the scoring, wherein all scores over a minimum match score value are checked against any duplicates in the array. The groups are sorted such that a report is created for the user to perform the operations on the potential duplicate data, and the matching routines allow for the scoring by being adapted to compare fields selected from the group consisting of date of birth, name, sex, social security number, maiden name, and alias. For the registration process, a transaction record is then created based on the new duplicate data, wherein the transaction records may be sent throughout various ancillary systems including back to said host database for logging and updating, thereby keeping the hospital database updated in “real-time”.

### BRIEF DESCRIPTION OF THE DRAWINGS

FIG. 1 is a process flow diagram showing the overall process implementing the three tools.

FIG. 2 is a flow diagram demonstrating the steps performed by the find tool for data field comparison.

FIG. 2a is a flow diagram demonstrating how and what type of field comparisons are made by the find tool.

FIG. 3 is a flow diagram demonstrating the steps performed by the merge tool for merging of the patient records.

FIG. 3a is a user interface showing the available options that may be activated during the merge process.

FIG. 3b is a user interface showing an example of a potential duplicate patient report.

FIG. 4 is a flow diagram demonstrating the steps performed by the guard tool for data duplication minimization during a patient registration process.

FIG. 4a is a flow diagram continuing to demonstrate the guard tool when the transaction records are created.

The flow diagrams as presented herein represent applications that can be performed using a general-purpose computer programmed with software or as circuitry used by a specialized device. Accordingly, the steps represent software or logic flow that can be implemented in discrete programs or circuits.

### DETAILED DESCRIPTION OF THE PREFERRED EMBODIMENT

A master patient index (MPI) as termed herein is a hospital's database system of patient data residing on a client server or client host PC, accessible by a local or remote computer/server. Duplicate records are multiple records of the same person resulting from typical multiple visits. The MPI is queried through a hospital interface, which returns the necessary data to a formed delimited text file 20, wherein the information is separated by pipes, commas or the like. This text file of data records 22 is loaded into a host database 10 preferably using a pl/sql script. The host database is then the remote server or task-based database platform residing therein that performs the applications as described herein over a network using database software. The network may be an intranet or internet computer or digital network accessible by any dial-up, cable, wireless, or digital connection. The present invention is not limited as to the type of computer on which it runs. A computer typically includes an input device such as a keyboard, touchpad, and/or mouse, and a display device such as a monitor. A computer also typically comprises a random access memory (RAM), a read only memory (ROM), a central processing unit (CPU), and a storage device such as a hard disk and/or floppy drive. All tools are web-enabled and preferably, all client PC's have a Java® runtime environment and JDBC drivers installed (allows client to view screens and client data), although other applications may be used. For example, the tools may be written using Java ® and converted to C++ or vise versa where a Java ® application automates the procedures. From the client (hospital) site, users sign on to the host server using a secured connection (secured socket layer or SSL).

### Find Tool 14

Depending of the size of the hospital database, preliminary search algorithms may break down the size of the database into smaller tables 12, preferably (but without limitation) to twenty-four tables, by sex and month of birth for example. Other current division choices include not dividing, dividing only by month, dividing by month and sex, and dividing by sex only. Once all preliminary tables are established, the find tool algorithm is run on each of the tables to begin the comparisons 24. An example of the text version of the computer code that may be used to take the sex and birth month and eliminate non-matching records after such comparison is shown in the computer program listing appendix. The procedures shown in can be used to segregate the data by month or month and sex. The procedure will be used in the event that the hospital database (MPI) provided is too large to be processed as a whole. For example, a male sex having a birth month of December can be segregated from any non-matches.

The find tool 14 (algorithm) to be run on each table starts by setting field types and table associations. Counters are then initialized 24a from the number of patients in the data, and if there exists an exact match to a name in the nickname table. The specific fields to be compared 24 from the first patient record are then read into an array. An example of common fields used follows in table 1:

TABLE 1

| Field | Description |
|---|---|
| Patient Index | Relates back to database |
| | with all of the patient data |
| Patient Count | Number of patients in |
| | the table for comparison |
| Date of Birth | Includes Day/Month/Year |
| Name | Includes First/Middle/Last |
| Sex | Male/Female |
| Social Security # | Compares all digits |
| Maiden Name | NA |
| First Alias Last Name | NA |
| Second Alias Last Name | NA |

At times it may be necessary to customize the number of fields being compared, and subsequently the scoring should be customized accordingly. Therefore, the scores 205 and order of the searching may change from what is listed herein.

The patient record 21 that will be compared to the first, original record 23 is then read into the assigned table 25, and the comparisons begin 27. The comparisons do not need to be in any particular order, but preferably, either last name or the date of birth is the first.

Thus, the date of birth 201 is one field for comparison. If the entire date (month, day, year) matches exactly, a score of 6.9 is given to this portion, and the next field is then compared. If the entire date does not match, then each portion is checked and scored according to its match or non-match. A chart showing the scoring during the comparison of the date of birth fields is shown in below table 2.

TABLE 2

| MATCH | SCORE |
|---|---|
| Day Field Matches | 2.2 |
| Day Field Does Not Match | −1.3 |
| Month Field Matches | 1.7 |
| Month Field Doesn't Match | −1.2 |

The absolute value of the difference between the years is calculated and scored as follows in table 3 as an example:

TABLE 3

| Difference (Years) | Score |
|---|---|
| 10 | −2.7 |
| 9 | −2.5 |
| 8 | −2.3 |
| 7 | −2.1 |
| 6 | −1.8 |
| 5 | −1.4 |
| 4 | −1.0 |
| 3 | −0.6 |
| 2 | 0.4 |
| 1 | 1.3 |
| 0 | 3.0 |

The last name 203 is then matched as follows: the last names are checked for exact match, and if so, a score of 10 is given. If any of these matches are made, the ones that follow are skipped. If not exact, then several other comparisons are made such that other last name possibilities are matched. For example, if the first three letters of the last name match, a score of 6.9 is given. If the maiden last names 202 match exactly or the last name matches the maiden last name, then a score of 5.9 is given. If not, then if the sex matches 206, and a soundex 204 of the last name matches, a score of 5.0 is given. If not, then if the first three letters of the maiden name match, or the first three letters of the maiden name match the first five letters of the last name, a score of 3.9 is given. If not, then if the soundex of the maiden name matches or the soundex of the maiden name matches the soundex of the last name, then a score of 2.0 is given. If not, then if the alias1 to alias1 (alias 208), or alias1 to last name, or alias2 to alias2, or alias2 to last name match exactly, then a score of 2.0 is given. If not, then a soundex of: alias1 to alias1, or last name to alias1, or alias2 to alias2, or last name to alias2 matches, a score of 1.5 is yielded. If no last name match is made, then a score of −3.0 is given. If the middle name matches, a score of 1.0 is given. If there is no middle name match of one record and a middle name match for another record, a score of 0.5 is given. If the sex matches, a score of 1.5 is given, if it is not a match, then a score of −0.5 is given.

If the first name to first name matches exactly, then a score of 4.5 is given. If a soundex of first name to first name matches, then a score of 2.5 is given. If the first name matches a name in the nickname table 210 that corresponds to the first name of the second record, then a score of 3.0 is given. If no first name matches, then a score of −2.0 is used. The nickname table 210 contains (and is updated with) as many known name variations as possible.

Social security numbers are also then scored. An example of the Social Security Number (SSN) field scoring can be seen in table 4 below.

TABLE 4

| Match | Score |
|---|---|
| All Digits Match | 6.0 |
| Either record does not contain an SSN | 4.0 |
| First 4 Digits Only | 3.0 |
| Last 5 Digits Only | 3.0 |
| No Digits Match | −1.0 |

After all of the matching routines are completed 209, all records have a multiplier applied 26. This multiplier value is dependent upon the individual match scores and is customized accordingly. The multiplier is used to obtain a score of (or as close to) 100% for those groups that meet the greatest possible matches. All group scores over a set value of a minimum match score value 28, such as 60, are then checked against the duplicate table 220 to see if this comparison already exists. The minimum match score value 28 may be changed depending on the client's wishes and/or if the find tool 14 is altered to better suit the client's MPI. The match score value 28 is set such that any record with a match score of less than that value will be considered as being highly unlikely of being a potential duplicate. If the comparison does not exist 222 in the table, then it is inserted. If it does exist and the score is lower, then it is replaced with the higher score 224. Each group, as it is added, is assigned a group number 226 (sequenced by 1, starting with 1). The next record in the array is now used for comparisons.

The counters are set and sequenced 228 such that the following comparisons will be accomplished. For example, and by no means limited thereto, 100 records may be compared. All records are read into an array of records for comparison. For example, array elements for record 1 are compared to array elements for record 2 to n. Then the index is incremented and the array elements for record 2 are compared to the array elements 3 to n, and etc. After all comparisons, scores, and inputs into the duplicate table (if any) are complete, record 3 is read into the table for comparison to record 1. Record 1 will be compared to records 2 through 100, then the counter is sequenced, and record 2 is then compared to records 3 through 100, and so on until record 99 is compared to record 100. All of the groups that are entered into the table are then renumbered 229 based on their score, and placed in order (sorted), highest to lowest by score. This table is now ready for a report to be created, and/or the merge tool 30 is then utilized.

### Merge Tool 30

The database table groups that have been renumbered and ordered 229 containing all of the groups of possible duplicate records is now ready for the merge tool 30, which is a means for electronically merging the records as directed by the user.

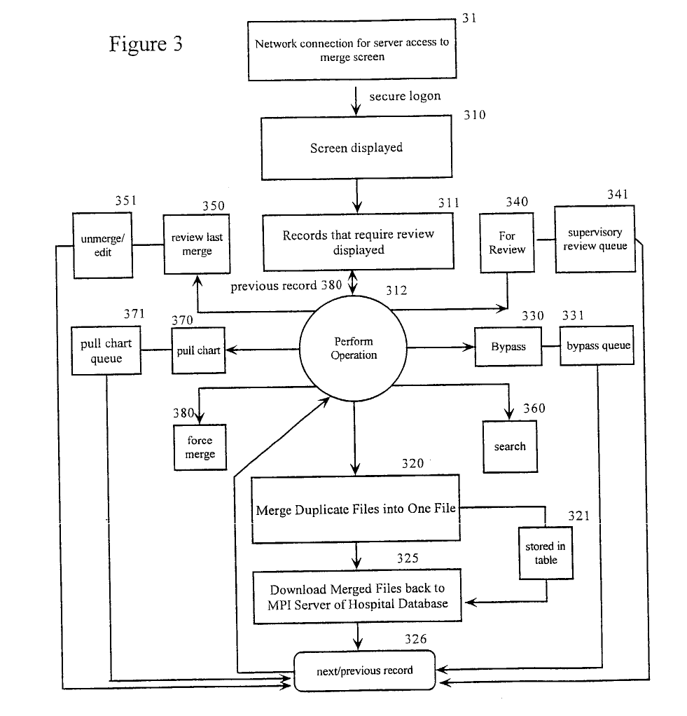

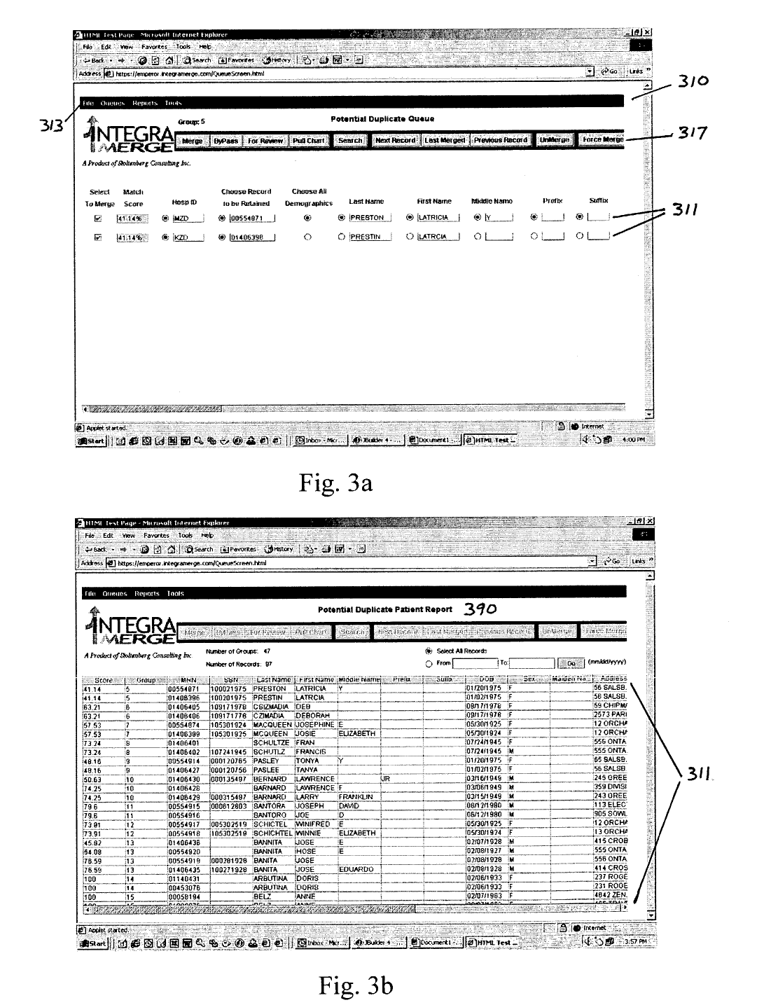

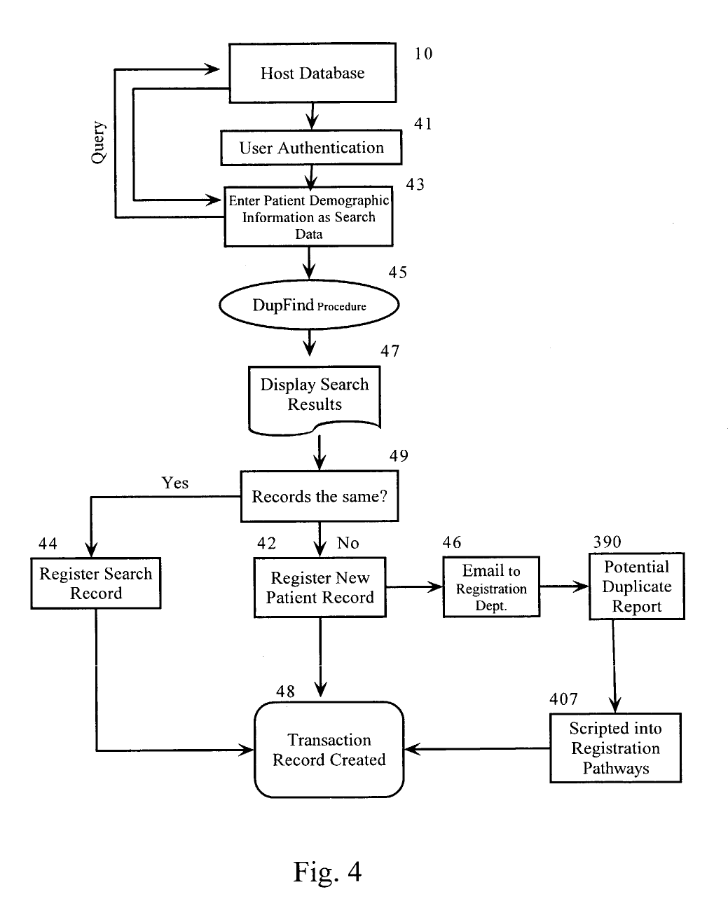

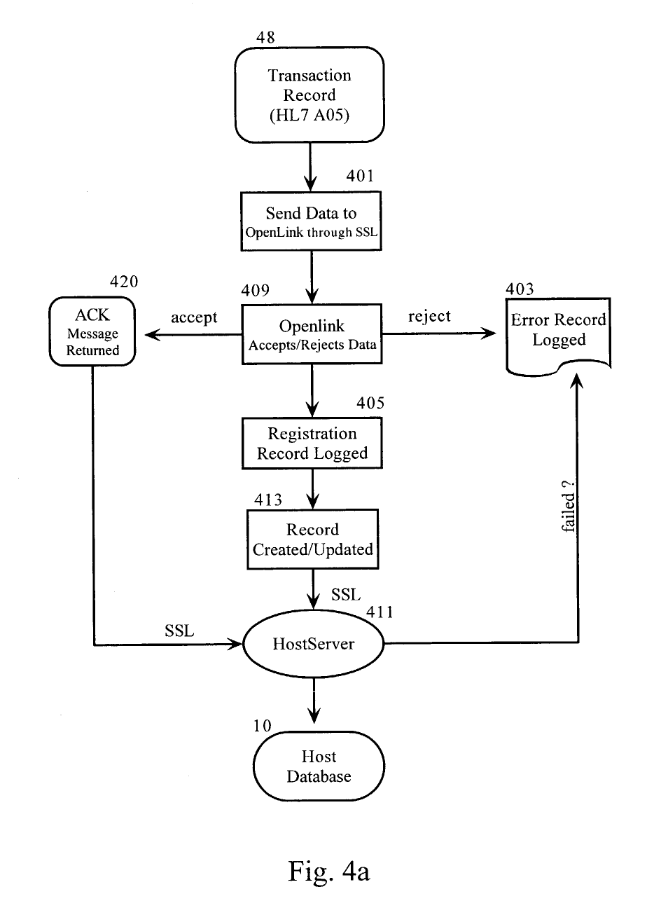

With reference then to FIGS. 3-3b, the user gains access to the Internet by means of a network connection 31 (dial-up, LAN, DSL, ISDN, etc.). The address of the server is typed into the browser and an authenticated connection is made to the host server as is generally known in the art. After display of the page, the user clicks on a link that redirects him or her to a secure logon page. Entering the correct username and password starts the applet and displays the merge tool screen 310. This screen 310 displays patient information of the grouped potential duplicates. The demonstrated user-interface shown in FIG. 3a shows two records of patient information as potential duplicate records 311. The merge tool 30 is capable of returning more than two records at one time. It allows for the choice of data from any of the returned records to be used as the final information, and allows the user to edit fields manually prior to the merge process. The fields that are shown for each of the potential duplicates are selected from the group consisting of those shown below in table 5:

TABLE 5

| | |
|---|---|
| Match Score | Hospital ID |
| Medical Record Number (MRN) | Last Name |
| First Name | Middle Name |
| Prefix | Suffix |
| SSN | DOB |
| Sex | Address 1 |
| City | State |
| Zip | Maiden Last Name |
| Alias1 Last Name | Alias1 First Name |
| Alias2 Last Name | Alias2 First Name |
| Marital Status | Race |
| Phone | Policy ID |
| Death Indicator | Comments |
| Hospital ID2 | MRN2 |
| Hospital ID3 | MRN3 |
| Hospital ID4 | MRN4 |
| Hospital ID5 | MRN5Table 5 |

All of these fields are editable except for match score, policy ID, and death indicator, and all fields can be chosen independently for merging.

The merge tool's screen 310 has a toolbar menu with menu items 313, which include File, Reports, Queues, and Tools. The file menu includes the choices of (1) Return to the Main Menu, or (2) Exit the Program. The Reports menu lets the user select from the options of Potential duplicate record, Chart Pull, Supervisor Review, Bypassed Record, and Merged Record.

An example of one report is shown as FIG. 3b. The Potential Duplicate Patient Report 390 shows all potential duplicate records 311 from the database in report form. Other reports include a Chart Pull Report, which shows all potential duplicates that have been sent to the pull chart queue 371. A Supervisor Review Report shows all potential duplicates that have been sent to the Supervisor Review queue 341. A Bypassed Record Report shows all potential duplicates that have been sent to the by-passed record queue 331. The Merged Record Report shows all potential duplicates that have been merged thus far.

The Queues Menu option in the menu items 313 provides the user with a selection from the following options; Potential Duplicate Record, Chart Pull, Supervisor Review, and Bypassed Record. Each queue category selected by the user will display the latest group of records in the queue.

From the Tools menu option of the menu items 313, the user can either select Download Report or Print Report. The Download Report function copies report to a disk. The Print Report prints the report to an attached printer.

The bar buttons 317, when actuated by clicking on the respective icon/link using an input device, actuates the operations on the group of records 311 being currently displayed. The Button/Functions are selected from the group consisting of those shown in table 6 below:

TABLE 6

| | |
|---|---|
| Merge | Bypass |
| For Review | Last Merge |
| Search | Next Record |
| Pull Chart | Previous Record |
| Unmerge | Force Merge |

The Merge button, when clicked, merges the current group (of potential duplicate data) 320 into one record or file. The merge mechanism is demonstrated using text version of code as shown in the computer program listing appendix wherein the data retained as correct is that which was selected and/or edited by the user. The data is sent to a table 321 where it is stored until the occurrence of the download back to the MPI server of the hospital database 325. The next (or previous) group of potential duplicate records is then displayed. The bypass button 330, when clicked, places the current group into the bypassed record queue 331 for further review. The next group of potential duplicate records is then displayed 326.

The for review button 340, when clicked, places the current group into the supervisor review queue 341. These records will be reviewed by someone of authority for duplication. The next group of potential duplicate records is then displayed 326. The last merge button 350, when clicked, displays the last merged group to the user. The previously merged group can then be unmerged, edited, and/or remerged 351.

When the search button 360 is clicked it provides the user with a search page with these available fields to be entered (table 7):

TABLE 7

| | |
|---|---|
| System ID | Medical record Number |
| Date of Birth | Social Security Number |
| Last name | First name |

Any or all of these fields can be entered for the search. This function searches the database of potential duplicate records.

The following description assumes that each button has been clicked. The next record button displays the next group of potential duplicates. The pull chart button 370 puts the currently displayed group into a pull chart queue 371 for review and requires someone at the hospital to pull the medical charts on these persons to determine if they are duplicated. The next group of potential duplicates is then displayed. The previous record button 380 displays the previous unprocessed group of potential duplicates. The unmerge button 351 can only be used after the last merge button 350 has been activated. When clicked, the last merged group will be unmerged and can be edited or otherwise processed 351 as described above. The force merge button will merge seemingly non-duplicate records as necessary.

Periodically, all processed data is automatically downloaded to the MPI server of the hospital database 325 for electronic merging within their database. The chart pulls 370 and supervisor reviews 341 are reported for these manual processes.

In summary, the client host PC, located at the client site, is required for the client to accept merge record transactions from the host server database. The PC will download a batch file on a regular basis that contains all merged records for that day. Once the merge file has been downloaded, either an automatic merge script or interface engine (HL7 format) will send the merge records to each designated client system and automatically merge the duplicate records within that system.

### Guard Tool 40

As termed herein, “HostServer” is an application that will reside at the client site which receives transactions from the registration system and then forwards them to the host database. The guard tool 40 is a front-end registration means for complementing the merge tool and ensuring that the hospital patient database has minimal patient duplications during a new input session. After the merge tool 30 has cleaned, or merged 320 (FIG. 3) all duplicate records in the enterprise access directory (EAD), a fresh load of data is extracted from EAD in delimited (i.e. pipe delimited) format and the data is refreshed in the host database.

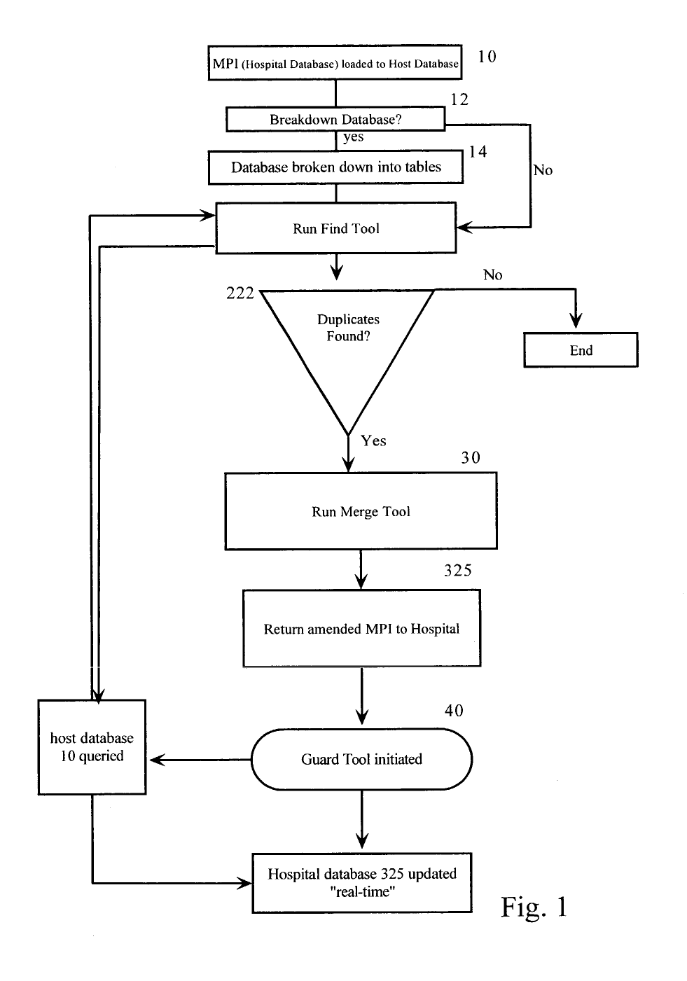

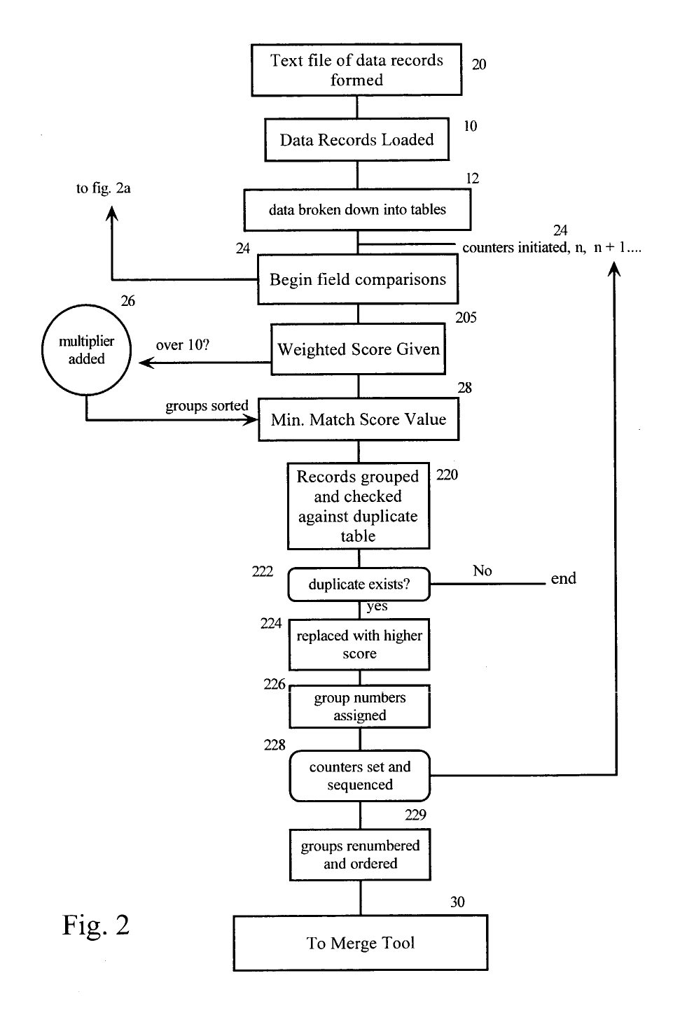

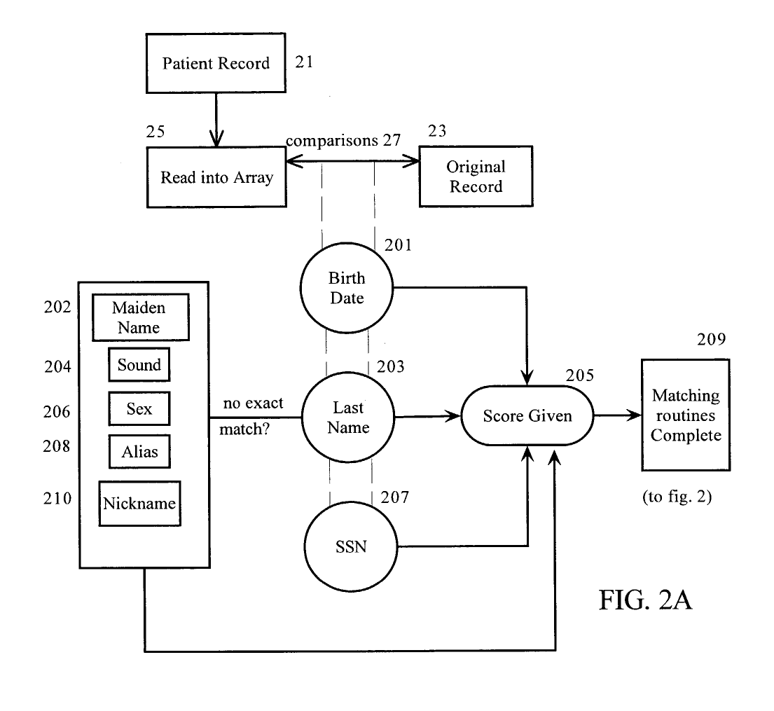

The registrar logs into the guard tool using the username and password, which is authenticated 41 in the host database 10. The front-end patient look-up screen will gather specific demographic information 43 about the patient being registered. Registrar enters the patient's basic demographic information 43 as search data. The application will then query the host database 10 to return any possible patient matches. The search data is run against a find (dupfind) procedure 45 (dupfind.sql), which takes the search parameters of the search data and searches for the data in the host database using a probabilistic matching algorithm. Similarly as compared to the find tool 14 (FIG. 1), this procedure is called from the guard tool 40 to verify the patient being registered does not already exist in the hospital database 10, so each matched data element is scored according to the accuracy of the match and the final score totaled. The user has the ability to determine up to what percentage of match-score they want to view as the search result. Thus, the guard tool application will return a percentage with each record that will indicate the likelihood of that record matching the data entered. Search results, for example, may be displayed 47 with the order of descending match score, and if no records are returned, it indicates that the patient is a new patient.

The user (registrar) will select the appropriate record based on the information presented. The registrar must decide whether one of the search result records is the same 49 as the patient they are trying to register. If the registrar decides that it is not the same person, the registrar must choose to register a new record 42. If the decision is made that it is the same person, then that record must be registered 44 and an existing record will be updated. If the registrar decides to create a new registration record 42 even though the results indicate that there is a high probability that it is the same person, then the search data and the search results are emailed 46 to necessary authorities and the records are added to the potential duplicate report 390. The selected record will then be scripted into the registration pathways 407 for system processing and updating.

A registration system, such as that utilized by Siemens Medical Solution (SMS), will then create transaction records 48 based on the registration information that will be passed back to the patient database where the existing records will be updated based on the registration information. So once the registrar registers a patient, a HL7 A05 segment transaction record 48 is created dynamically and sent to OpenLink 409 through Java Socket Protocol 401. If the HL7 A05 segment is successfully inserted into EAD, then OpenLink returns an ACK message 420. If the HL7 A05 segment is rejected then an error log is created 403.

On the host database 10 side, a SSLSocketReader program listens continuously in on the Secure Socket Layer (SSL) for any transactions processing in EAD through OpenLink 409. OpenLink 409 sends all HL7 transactions processed in EAD to HostServer 411. HostServer 411 logs the record and forwards the record to the SSLSocketReader via SSL and then appropriate changes are made to the host database 10.

Another important function of HostServer 411 is if the host database 10 is unavailable, then the registration records are logged 405 and it keeps on checking the status of the host server hosting the host database 10. When the server can function accordingly again, all the backlogged registration records 413 are sent the host database 10. Any failed records are sent to an error log 403. The SSLSocketReader program parses the HL7 transaction and depending on the type of the HL7 transaction event, it determines whether the incoming an insert/update or delete into the host database 10.

This offers full circle processing to reduce the number of duplicates due to the registration process. It also maintains up-to-date information while the back-end processing of duplicate medical record cleanup continues. Therefore, the duplicates are kept to a minimum.

This process can be setup as an Intranet process, where the database resides within the hospital organization, or an Internet process, where the database resides at the host database location.

### EXAMPLE

So generally, the guard tool means is comprised of a data entry screen where patient demographics will be entered and passed to the host database. Database records that match the entered data will be passed back to the hospital database. Each record will contain a probability match percentage based on the matching algorithm. The user will then select the appropriate record that will be passed to the SMS application via scripting. Therefore, the registrar will not have to re-enter data into SMS. The list below contains the data that the registration personnel will have an opportunity to enter into the Guard Tool application for lookup into the database.

1). Patient Name Prefix (optional)

2). Patient Last Name (required)

3). Patient First Name (required)

4). Patient Middle Name (optional)

5). Patient Name Suffix (optional)

6). Patient Date of Birth (required)

7). Patient Social Security Number (optional)

8). Patient Maiden Name (optional)

9). Patient Sex (required)

10). Patient Race (optional)

11). Patient Medical Record Number (optional)

12). Hospital Identified (defaulted)

The guard tool will place the entered information on the first line of the returned screen. All records pulled from the database will be listed next in order of algorithm percentage in descending order. The user will select the desired record by clicking on the line itself or a selection button to the left of the data. The number of records returned from the database is directly related to the amount of information that is entered and passed to the database look-up module.

Buttons:

1). SELECT—select the associated record

2). OK—submit data to SMS

3). CANCEL—clear all fields and return to blank entry screen

4). NEW SEARCH—return to entry screen with an intermediate prompts (HOLD/CLEAR)

a). HOLD DATA—keep data entered when returning for revising

b). CLEAR DATA—clear all fields and return to blank entry screen

5). NOTIFY MEDICAL RECEIPT DEPARTMENT (This would be based on the patient confirmation that a duplicate exists. (Ex. that was my maiden name I was married 3 months ago.) Upon selecting this button a COMMENT box would open for registration to enter text based on information the patient provided.

a). COMMENT BOX—free text 500 characters.

1). PRINT—prints a document page to medical records that identifies a duplicate.

2). EMAIL/NETMSG—sends an electronic notification to Medical Records that identifies a duplicate.

Depending on the option chosen this could have an impact on the ancillary systems or registration time.

The following information will be displayed upon return from the database lookup.

1). Patient Medical Record Number

2). Patient Social Security Number

3). Patient Date of Birth

4). Patient Name Prefix

5). Patient Last Name

6). Patient First Name

7). Patient Middle Name

8). Patient Name Suffix

9). Patient Maiden Name

10). Patient Alias Last Name

11). Patient Alias First Name

12). Patient Alias Middle

13). Patient Sex

14). Patient Race

15). Patient Address Line 1

16). Patient Address Line 2

17). Patient Address City

18). Patient Address State

19). Patient Address Zip

20). Patient Phone

21). Patient Death Indicator

22). Marital Status

Based on the record selected by the user the following information will be scripted into SMS to start the registration process.

1). Patient Medical Record Number

2). Patient Social Security Number

3). Patient Last Name

4). Patient First Name

5). Patient Middle Name

6). Patient Sex

7). Patient Birth date

The user will also select the type of registration. The button selected will identify which SMS registration pathway the script will follow. Examples: Inpatient Admit, Inpatient Preadmit, Outpatient Registration, ER Registration, Preadmit to Admit and Recurring registration just to name a few.

### SMS Look-Up

This step in the process depends on hospital procedures and whether it has an enterprise access directory (EAD).

A). If EAD is implemented, generally the registration process will force an EAD look-up before the registrar can proceed with an application registration. Therefore, an EAD look-up will be performed first.

B). If the EAD is NOT implemented at the site then the registration information will be sent to Invision.

C). Various registration points within the hospital and clinics areas may have different registration pathways (i.e. Inpatient, ER, outpatient). Therefore, custom OAS programming may need to be performed to tailor the registration processes and standardize the Guard Tool hook. Also the selection of the registration type will be passed so the proper pathway will be initiated.

The SMS look-up screens are broken down into two categories.

1). Numeric Inquiry

2). Phonetic Inquiries

The information selected from the application screen will be passed to SMS.

A). If the medical record number is passed from the application screen. Then patient information will be accessed via numeric inquiry using the medical record number. Hence selecting the exact patient chosen from the look-up process.

B). If the medical record number is NOT passed from the application screen. Then the phonetic inquiry will be initiated using the following fields where information is available.

Last Name

First Name

Sex

Birth Date

Social Security Number

This process could produce multiple records to choose from or a new medical record could be created.

### SMS Database Update

As the registration process finishes the SMS database is updated and interface transactions are created. The SMS system produces HL7 (Health Level Seven format) or fixed format file transactions. These transactions carry the registration and update information to various ancillary systems (i.e. Lab, Pharmacy, and Radiology). It is through this process that the guard tool system will be updated. Even though the guard tool means initiated the registration process, various registration information could be updated that would impact the next guard tool lookup. (i.e. phone, address, . . . ). Therefore, it is important to pass this information back to the guard tool database.

During the patient life cycle in SMS the patient demographics can be updated at various stages. It will be necessary for the guard tool to capture this information. The following are a list of transactions and HL7 events (as shown in below table 7), which would be captured and passed to the Guard Tool.

Table 7

### Super Record Transactions

HL7 Events

| | |
|---|---|
| Admission | A01—Admit |
| Change Patient Number | A03—Discharge |
| Revise | A04—Register Patient |
| Baby | A05—Preadmit Patient |
| Discharge | A08—Update Patient |
| Info | A09—Departing |
| Patient | A10—Arriving Patient |
| | A11—Cancel Admit |
| | A13—Cancel Discharge |
| | A18—Merge Patient |
| Information | A23—Delete Patient |
| Record | A28—Add Person |
| Information | A31—Update Person |
| Information | A32—Cancel Patient |
| Arriving | A33—Cancel Patient |
| Departing | Z03—Enter Visit |
| | Z04—Cancel Visit |
| | Z05—Verify Visit |
| | Z06—Revise Visit |
| | Z07—Postpone Visit |

### Database Update

The convert program will read in HL7 formatted transactions that will update, add, or delete records based on the incoming transaction type. Information related to visit and patient index (PIDX) records will be retained. For auditing purposes the information will not be actually deleted. It will be flagged as deleted so that it could be retrieved at a later date and will not be passed as an active record to the guard tool front-end program.

Any new medical records added to the database will also be added to a holding file. This holding file can be matched with the full database to determine if any new duplicates were created. The key to both files will be the internal sequence number. This number will be used so that the holding file will not match against its mirror record in the database, thereby eliminating an identification of a duplicate record against itself.

In addition to this process, the transactions created by the merge tool and the match processes will be passed back to the database. This creates a full circle process that will keep the database updated “real-time”.

I claim:

1. A duplicate resolution system for allowing a user to manage hospital database records in a hospital database, comprising:
a find tool means for allowing a host database to identify potential duplicate data within said hospital database, wherein potential duplicate data is scored using matching routines;
a merge tool means for allowing said user to review said potential duplicate data online from said host database, wherein said user may choose from a plurality of operations to be performed on said potential duplicate data based on said score, wherein at least one of said operations is adapted to allow for a merging of two or more potential duplicates in said potential duplicate data into one record; and,
a guard tool means for preventing new duplicate data during a registration process, wherein said host database is queried to indicate a likelihood that said new duplicate data is a match to an existing record within said hospital database.

2. The system of claim 1, wherein said find tool means further comprises a means for breaking down said potential duplicate, thereby forming a group of tables containing fields.

3. The system of claim 2, wherein said matching routines allow for such scoring by being adapted to compare said fields of said group, wherein said fields are selected from the group consisting of date of birth, name, sex, social security number, maiden name, and alias.

4. The system of claim 1, wherein said merge tool means further comprises a merge tool screen for displaying said potential duplicate data.

5. The system of claim 4, wherein said merge tool screen further comprises a tool bar menu with menu items.

6. The system of claim 5, wherein said menu items are selected from the group consisting of file, reports, queues, and tools.

7. The system of claim 4, wherein said merge tool screen further comprises a plurality of bar buttons for allowing said user to actuate said operations.

8. The system of claim 1, wherein said guard tool means further comprises a means for creating transaction records based on said new duplicate data, wherein said transaction records may be sent throughout various ancillary systems including back to said host database.

9. The system of claim 8, further comprising a means for listening continuously in on a secure socket layer for any transactions creating said transaction records.

10. The system of claim 8, further comprising a means for logging said transaction records and continuously checking a status of said host database.

11. A duplicate resolution method for allowing a user to manage hospital database records in a hospital database, comprising the steps of:
loading said hospital database records into a host database to allow for an identifying of potential duplicate data within said hospital database;
scoring said potential duplicate data using matching routines;
allowing a user to review said potential duplicate data online from said host database;
allowing said user to perform one or more operations on said potential duplicate data based on said score, wherein at least one of said operations is adapted to merge two or more potential duplicates in said potential duplicate data into one record; and,
preventing new duplicate data during a registration process by allowing said user to query said host database to indicate a likelihood that any new duplicate data is a match to an existing record within said hospital database.

12. The method of claim 11, wherein after the step of loading said hospital database records, one or more fields of said potential duplicate data is read into an array to form groups for such scoring, wherein all scores over a minimum match score value are checked against any duplicates in said array.

13. The method of claim 12, wherein said groups are sorted such that a report is created for said user to perform said operations on said potential duplicate data.

14. The system of claim 11, wherein said matching routines allow for such scoring by being adapted to compare fields selected from the group consisting of date of birth, name, sex, social security number, maiden name, and alias.

15. The method of claim 11, wherein for the step of preventing new duplicate data during a registration process, a transaction record is created based on said new duplicate data, wherein said transaction records may be sent throughout various ancillary systems including back to said host database for logging and updating.

16. A duplicate resolution method for managing hospital database records, comprising the steps of:
allowing said hospital database records to be loaded into a host database to allow for an identifying of potential duplicate data within a hospital database;
allowing said potential duplicate data to be scored within said host database using matching routines;
reviewing said potential duplicate data online from said host database;
performing one or more operations on said potential duplicate data group based on said score; wherein at least one of said operations is adapted to merge two or more potential duplicates in said potential duplicate data into one record; and,
querying said host database to indicate a likelihood that any new duplicate data is a match to an existing record within said hospital database.

17. The method of claim 16, wherein said operations further include placing said group into a bypass record queue, placing said group into a supervisor review queue, placing said group into pull-chart queue, unmerging said group, and force merging said group.

18. The method of claim 16, further comprising the step of receiving a transaction record created based on said new duplicate data, wherein said transaction records may be sent throughout various ancillary systems including back to said host database for logging and updating.
